(19) United States
(12) Patent Application Publication
(10) Pub. No.: US 2024/0139596 A1
(43) Pub. Date: May 2, 2024

(54) COUNTER-ROTATING DIVOT REPAIR APPARATUS

(71) Applicant: Kevin HARTWIG, Colorado Springs, CO (US)

(72) Inventor: Kevin HARTWIG, Colorado Springs, CO (US)

(21) Appl. No.: 17/977,858

(22) Filed: Oct. 31, 2022

(51) Int. Cl. A63B 57/50; B67B 7/16

(52) U.S. Cl. CPC A63B 57/50; B67B 7/16

(57) ABSTRACT

A counter-rotating divot repair apparatus includes counter-rotating handles coupled to a tang of a head member. The head member includes a pair of tine members projected anteriorly from the tang along parallel or substantially parallel axes bounding an intermediary space. In the closed position, the head member is concealable inside channels disposed along interior edges of the handles. Manipulation of the apparatus to an open position counter-rotates each of the pair of handles 180° whereby the head member is revealed projected anteriorly therefrom. As a result, the apparatus is deployable between the open and closed positions onehandedly.

### BACKGROUND OF THE INVENTION

Various divot tools are known in the art. When playing golf, oftentimes the club head may scuff the turf during a drive, upending a clod of earth. Additionally, when balls land on the fairway or green, they sometimes upend clods of earth or otherwise cause breaks in the surface thereof. Divot tools are used to repair said “ball marks” and help to maintain golf courses, restoring conditions for other players. Additionally, many divot tools seen in the art are configured to serve as ball markers.

Divot tools seen in the art are typically sized for portability interior to a pocket or clipped to an item of apparel. They typically include a pair of prongs, or tines, anteriorly projected from a body member which a player may use to manipulate upended clods back into position on the green or fairway. Some divot tools double as keychains or bottle openers, while others are configured to enable retraction of the body member into a single handle for portability and storage. Such retractable embodiments essentially enable forward and rearward movement of the body member slidably coupled into the body member. While these embodiments enable the possibility of onehanded operation, though two handed is more likely, the movement of the tines coplanar with the direction of force applied in use of the tool means some locking, or other, mechanism is required to prevent inadvertent retraction of the body member.

What is needed in the field is a counter-rotating divot repair apparatus that enables a tined head member to be deployed from securement interior to a pair of handles by counter-rotatable action of said pair of handles. Counter-rotating the handles through a series of manual gestures enables onehanded operation of the apparatus between an open position and a closed position. In the open position, the hard member is deployed anteriorly projected from the pair of handles. Force applied in use of the tool is distributed through a tang at right-angles to the plane of rotation, thereby preventing inadvertent collapse of the head member in use. In the closed position, the head member stows interior to the pair of handles to position the pair of tine members safely enclosed thus preventing unwanted contact therewith.

### FIELD OF THE INVENTION

The present invention relates to divot repair apparatuses, and more particularly, to a counter-rotating divot repair apparatus having a pair of counter-rotating handles rotatably connected to a head member whereby a series of onehanded manual gestures enables opening and closing of the apparatus. The pair of handles enclose the divot repair head member interior to a channel in each of the said pair of handles, when the device is moved to the closed position for safe portage and storage of the apparatus.

### SUMMARY OF THE INVENTION

The instant counter-rotating divot repair apparatus has been devised to enable onehanded opening of the apparatus through a series of manual gestures and thereby position a head member, storable when stowed interior to a pair of handles in a closed position, anteriorly projected from the pair of handles in an open position whereby the force applied to the head member during use of the apparatus, to repair divots and ball marks on fairways and greens, is directed through a tang at right angles to the fastening means rotatably coupling the handles to the tang.

Each of the pair of handles has a first end rotatably coupled to the tang. Thus, while the pair of handles are grasped, the head member cannot be restored to the closed position. Similarly, when the apparatus is disposed in the closed position, as will be set forth herein below, the head member cannot be deployed to the open position.

The device, therefore, presents a means of safely storing the head member contained within the pair of handles when adjacently disposed in the closed position while enabling rapid onehanded deployment of the head member for use in the open position, as will be described herein below.

The present counter-rotating divot repair apparatus, therefore, includes a head member having a pair of tine members anteriorly projected from a tang. Each of the tine members are adjacently disposed along parallel, or substantially parallel, or slightly divergent axes, on either side of an intermediary space. A pair of handles is rotatably coupled upon the tang, rearwardly directed compared to the pair of tine members.

Each of the pair of handles has a length at least the same as, or greater than, the length of the head member. Each of the pair of handles includes a first end, a second end, an interior edge, and an exterior edge. A channel is disposed longitudinally along at least the interior edge of each of the pair of handles. The channel may extend entirely or partially through the handles from the interior edge to the exterior edge. Each said channel has a depth at least sufficient to accommodate longitudinally at least one half of the head member therein so that when the handles are placed together with interior edges adjacently conjunct, the head member is entirely concealed and stored interior to the channels. Conversely, when each of the pair of handles is rotated one-hundred-and-eighty degrees, so that the exterior edges are disposed adjacently conjunct, then the head member is exposed, projected anteriorly at the first ends of the pair of handles.

In an example embodiment contemplated herein, the tang includes a first pair of tang pins coaxially disposed perpendicularly on either side of the tang. When the handles are disposed in the closed position, each of the first pair of tang pins is caused to engage into a curved recess cut into the interior edge of each of the pair of handles. The first pair of tang pins, therefore, is engaged circumferentially in each curved recess between each of the pair of handles and supported therein when the handles are positioned with the interior edges adjacently conjunct. This arrangement stabilizes the tang in relation to the handles' first ends and increases the overall integrity of the individual parts of the apparatus.

The tang may additionally include a second pair of tang pins, of like capacity as the first pair of tang pins, coaxially disposed perpendicularly on either side of the tang, but spaced forwards from the first pair of tang pins more proximal to the tine members. In like capacity as already described in regard to the first pair of tang pins, when the handles are disposed in the open position the second pair of tang pins are likewise engaged in recesses cut into the exterior edges of the handles, to support and stabilize the device in the open position.

To increase stability and security of the apparatus, the pair of handles may include a mechanism allowing them to be fastened together in each of the open and closed positions by means of an interconnecting member disposed at the handles' second end, say, or by magnetic attachment. Magnetic portions, or members, may be incorporated at, along, or within each of the pair of handles, for example, to couple the handles together in edgewise contact when disposed in each of the open and closed positions until such force be applied as sufficient to supersede the magnetic attraction coupling the handles together.

In an example embodiment contemplated herein, the tang further includes a notched portion proximal one of the pair of handles and configured to function as a bottle opener.

The user may effectuate movement of the instant counter-rotating divot repair apparatus between the open and closed positions by simply grasping one of the pair of handles and, with action applied by the wrist, throw open the other of the pair of handles to reveal the head member. The user may then swing the free handle in another direction to reposition it over the dorsal aspect of the hand for capture when a third motion is effectuated to bring the free handle into contact with the palm.

The instant counter-rotating divot repair apparatus, then, has been devised to enable onehanded opening and closing to deploy a divot repair tool in a fun and novel way for use on the fairway or green, while offering a design which entirely minimizes the likelihood of a tine member catching on, or pulling out, a thread and either damaging a bag or misshaping the tool itself.

The user may also use the present apparatus to open bottles, as the case may be.

Thus has been broadly outlined the more important features of the present counter-rotating divot repair apparatus so that the detailed description thereof that follows may be better understood and in order that the present contribution to the art may be better appreciated.

Objects of the present counter-rotating divot repair apparatus, along with various novel features that characterize the invention are particularly pointed out in the claims forming a part of this disclosure. For better understanding of the counter-rotating divot repair apparatus, its operating advantages and specific objects attained by its uses, please refer to the accompanying drawings and description.

### BRIEF DESCRIPTION OF THE DRAWINGS

FIGS.

FIG. 1 is a bottom diagonal elevation view of an example embodiment in a closed position.

FIG. 2 is a bottom elevation view of an example embodiment in a closed position.

FIG. 3 is a bottom elevation view of an example embodiment in an open position.

FIG. 4 is a bottom elevation view of an example embodiment in between the open position and the closed position.

FIG. 5 is a top elevation view of an example embodiment in the closed position.

FIG. 6 is a bottom diagonal elevation view of an example embodiment in the open position.

FIG. 7 is a bottom diagonal elevation view of an example embodiment in between the open position and the closed position.

FIG. 8 is a bottom diagonal elevation view of an example embodiment in the closed position.

FIG. 9 is a bottom diagonal elevation exploded view of an example embodiment in the open position.

FIG. 10 is a top diagonal elevation exploded view of an example embodiment in the open position.

### DETAILED DESCRIPTION OF THE DRAWINGS

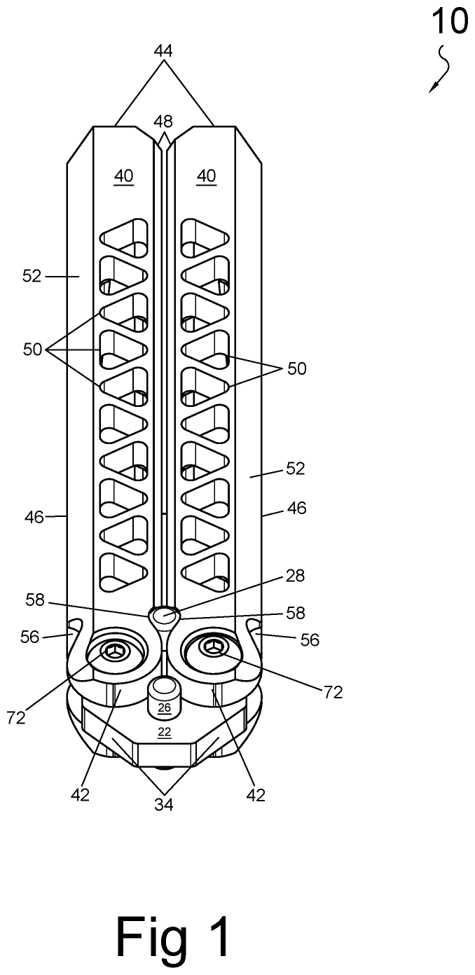

The present invention, shown herein with example embodiments in FIGS. 1 through 10, has been devised to enable onehanded opening and closing whereby a head member may be positioned for use and storage, alternately projected anteriorly from a pair of handles and enclosed within said pair of handles, respectively.

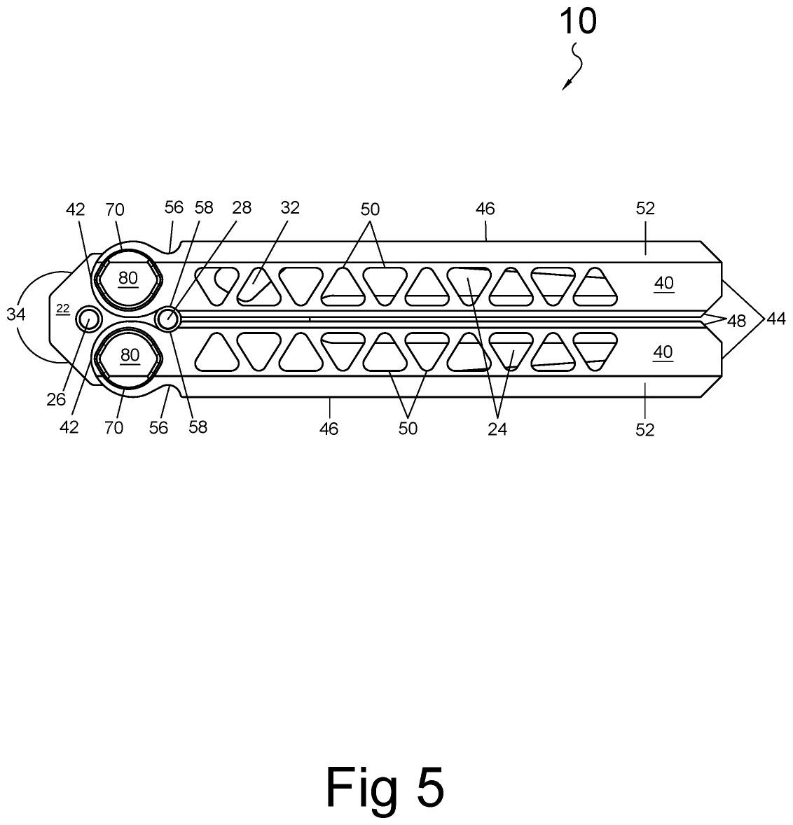

Referring to FIG. 1, a bottom diagonal elevation view illustrating the instant invention 10 is shown. Tang 22 of head member 20 is shown exteriorly protruding from first ends 42 of pair of handles 40. Pair of handles 40 is rotatably coupled to tang 22 by means of fastener members 70 inserted therethrough (see, e.g., FIG. 5). In this example embodiment shown, second fastener members 72 seat interior to fastener members 70, thus enabling fixed attachment of pair of handles 40 to tang 22 while facilitating counter-rotation of each of pair of handles 40 thereabouts, as will be discussed herein below.

In the example embodiment shown, pair of handles 40 include perforations or holes 50 to lessen overall weight of the apparatus 10. Additional embodiments are contemplated without such perforations or holes 50, where the weight differential is adjusted for via alteration of the manufacturing material, while other configurations of said perforations or holes 50, or other cutaways, lessen weight of the apparatus 10, where such is desired as when, say, the apparatus is rendered of cast metal.

Each of the pair of handles 40 includes a first end 42, a second end 44, an exterior edge 46, and an interior edge 48. Sloped longitudinal sections 52 are disposed edgewise along each exterior edge 46 to present a more compact and lightweight profile of the apparatus 10 as well as offer surface variation for tactile manipulation by a user.

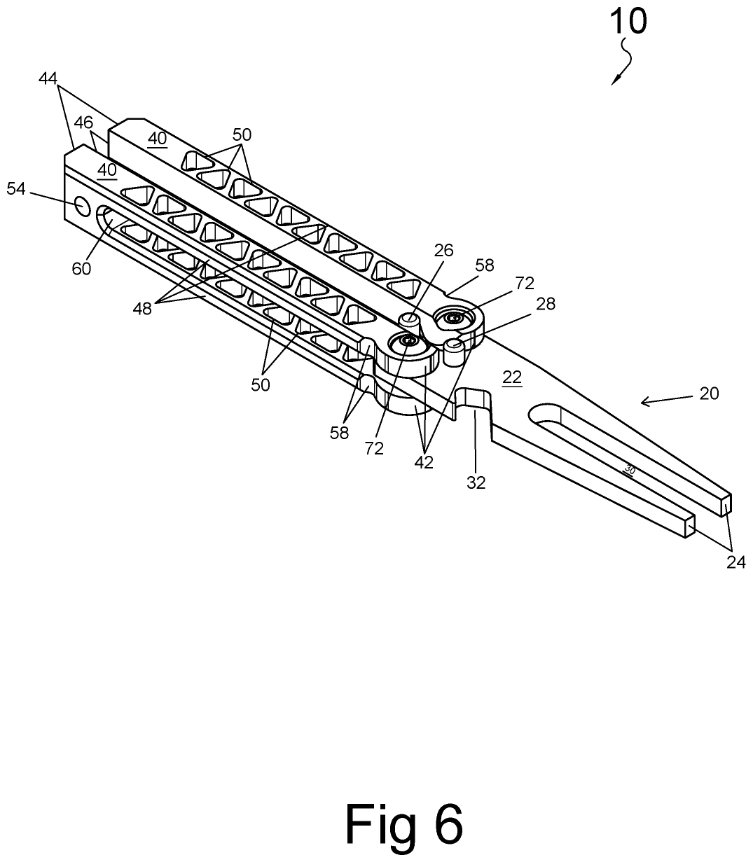

When disposed in the closed position, as shown in FIG. 1, interior edges 48 of pair of handles 40 are adjacently conjunct. Pair of handles 40 may be magnetically coupled, or interlocking, by means of magnetic portions or magnetic members 54 disposed upon each interior edge 48 of pair of handles 40 (see, e.g., FIGS. 6, 7, 9, and 10). In the example embodiment shown, corresponding magnetic portions or magnetic members 54 are disposed proximate to the pair of handles' 40 second ends 44 (see, e.g., FIGS. 6, 7, 9, and 10). Additional means of securing pair of handles 40 in the closed and open position are contemplated as within the scope of this disclosure, including for example, configuration of a latch member (not shown) disposed endwise upon the second end 44 of one of the pair of handles 40 to engage and interlock with second end 44 of other of pair of handles 40, as is seen in the art.

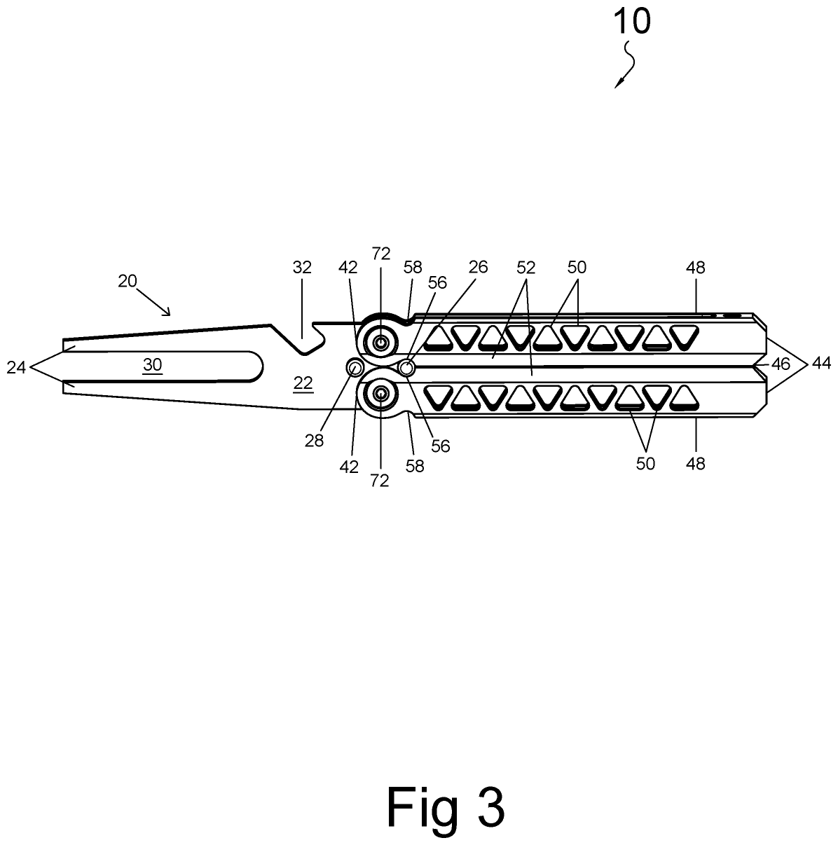

Tang pins 26, 28 are disposed to seat against arced recesses 58 on interior edges 48 and arced recesses 56 on exterior edges 46, to prevent over-rotation of the handles 40 while reinforcing the integrity of the apparatus 10 in each of the open and closed positions. Tang pins 26, 28 include a first pair of tang pins 26, disposed on either side of tang 22 and positioned to engage interior to arced recess 56 of each exterior edge 46 of the pair of handles 40 when moved to the open position (see, e.g., FIG. 3). Tang pins 26, 28 also include a second pair of tang pins 28 (of which only one of said pair is visible in FIG. 1) disposed to engage interior to arced recesses 58 disposed in interior edges 48 of the pair of handles 40 when moved to the closed position, as shown in FIG. 1.

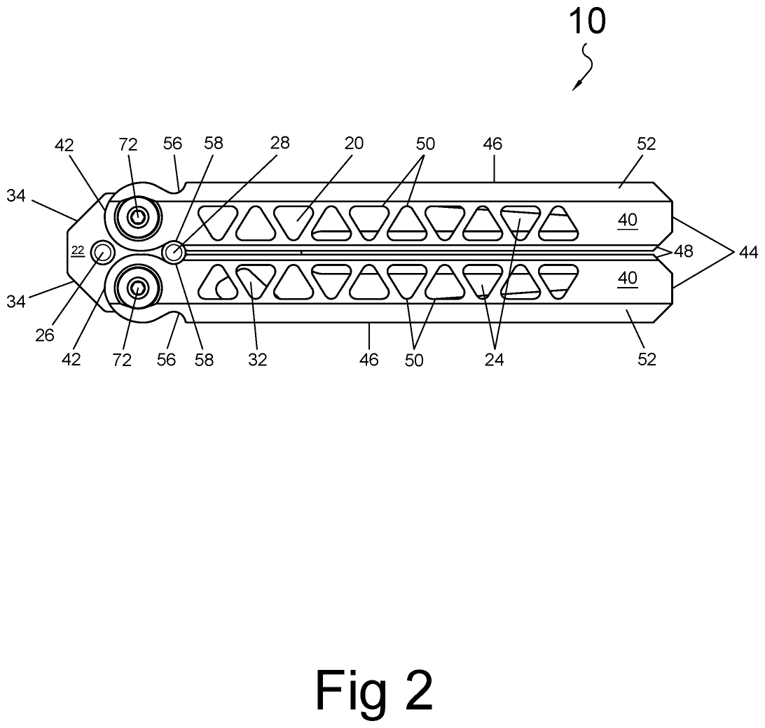

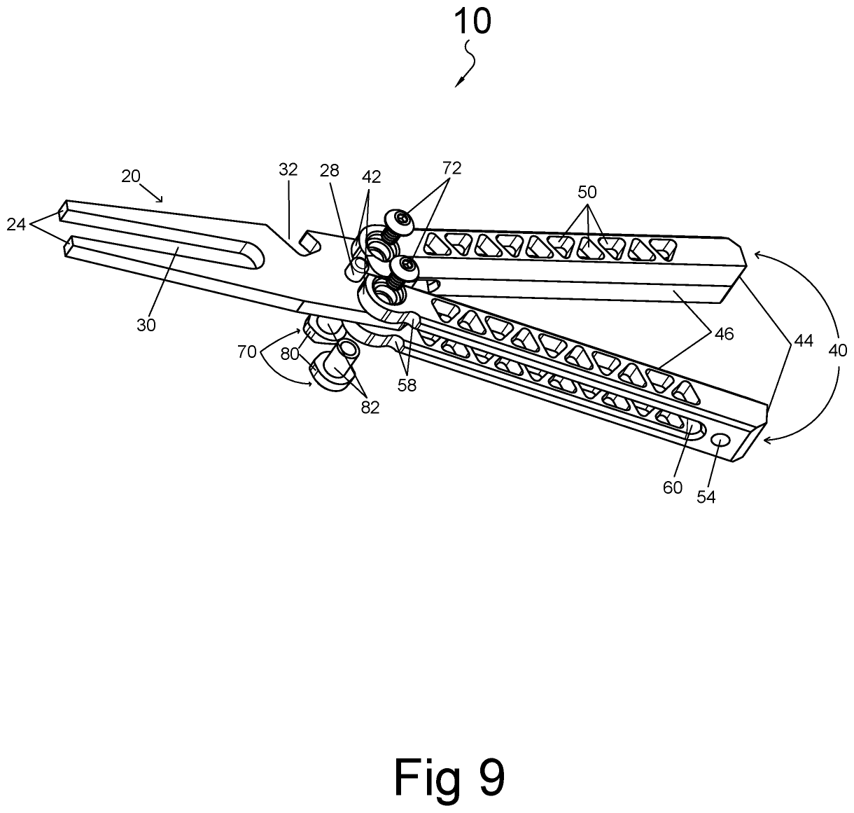

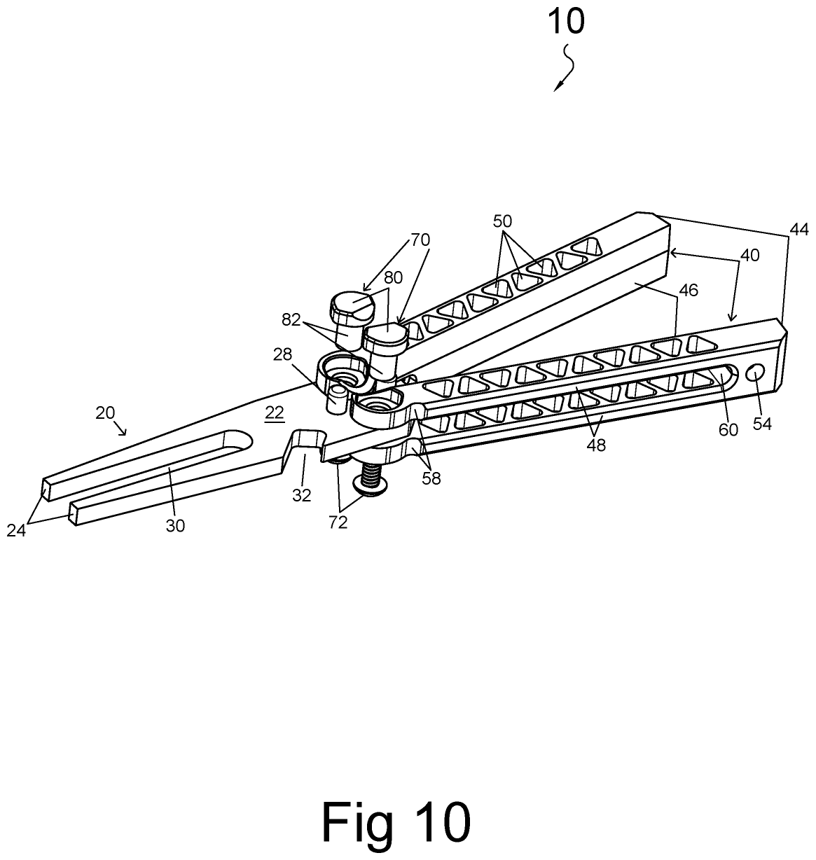

FIG. 2 illustrates a bottom elevation view of an example embodiment in the closed position. Head member 20 is visible through pair of handles 40 perforations or holes 50. Head member 20 is nested interior to channels 60 disposed along interior edges 48 of the pair of handles 40 (see, e.g., FIGS. 6, 9, and 10). Pair of tines 24 is disposed terminating proximal to the pair of handles' 40 second ends 44. Tang 22 is visible exteriorly projected at the pair of handles' 40 first ends 42. One of each of the pairs of first and second tang pins 26, 28 is shown on tang 22, one of the pair of second tang pins 28 engaged in arced recesses 58 of interior edges 48 of the pair of handles 40. Arced recesses 56 of exterior edges 46 of the pair of handles 40 are clearly shown, configured to engage circumferentially around the one of first pair of tang pins 26. Second fastener members 72 are shown seated interior to fastener members 70, wherein second fastener members 72 engage via threads to secure the pair of handles' 40 first ends 42 to tang 22 while enabling counter rotation thereupon (see, e.g., FIGS. 9 and 10).

FIG. 3 illustrates a bottom elevation view of an example embodiment disposed in the open position. Head member 20 is deployed anteriorly projected and the pair of handles 40 have been counter-rotated 180° so that arced recesses 56 in exterior edges 46 have engaged circumferentially about the first pair of tang pins 26. In like manner, as described previously for selectively securing the apparatus 10 in the closed position, the pair of handles 40 may include magnetic portions or magnet members 54 disposed upon at least sections of the exterior edge 46 to maintain and secure exterior edges 46 as adjacently conjunct until sufficient force is applied to supersede the magnetic attraction (see, e.g., FIGS. 6, 7, 9, and 10). As stated previously, additional means of selectively securing the apparatus 10 in the open position are contemplated as within the scope of this disclosure, including for example a latch member (not shown) configured to couple second ends 44 together, as is seen in the art.

Head member 20 includes a pair of tine members 24 disposed anteriorly projected bounding an intermediary space 30. In this example embodiment shown, a pair of tine members 24 is projected along parallel axes from tang 22. In this example embodiment, head member 20 also includes notched section 32 proximal to tang 22 and configured for use as a bottle opener.

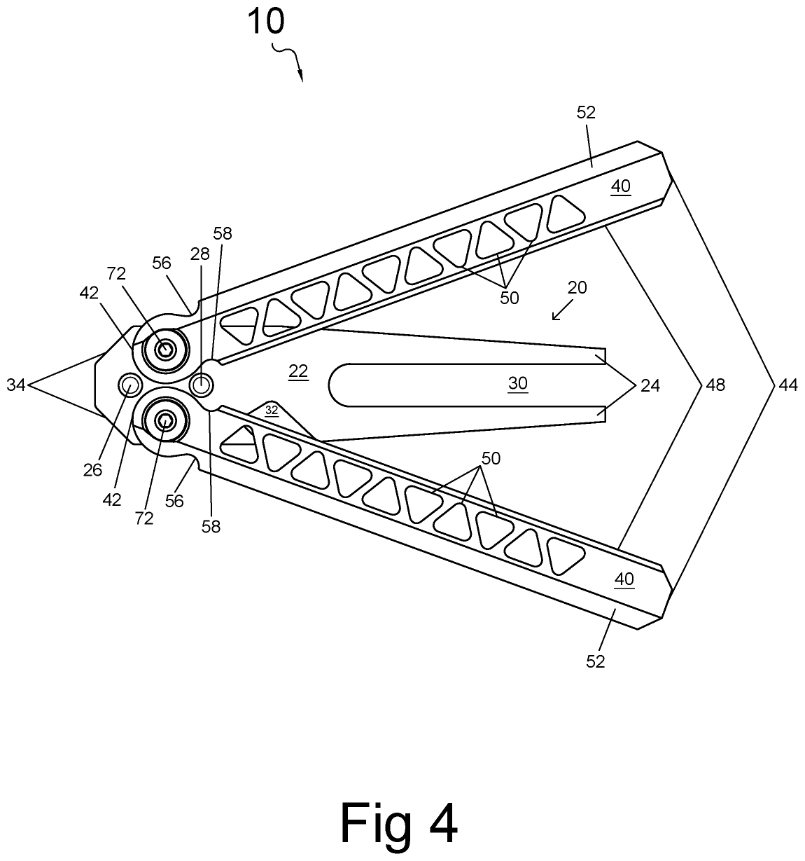

FIG. 4 illustrates a bottom elevation view of an example embodiment depicting the apparatus 10 between the open position and the closed position. When moving to the open position, the pair of handles' 40 first ends 42 counter-rotate and swing into open position thereby nesting one of first pair of tang pins 26 in arced recess 56. Tang base portions 34 seat interior to channel portions 62 disposed on exterior edges 46 at least proximal first ends 42 and of sufficient capacity and length to accommodate tang base portions 34 (see, e.g., FIGS. 6, 9, and 10). It should be noted that in example embodiments where channel 60 is configured to run from interior edge 48 to exterior edge 46 inclusively (thus all the way through each handle 40) (not shown), channel portion 62 may be incorporated therein (see, e.g., FIGS. 6, 9, and 10).

When moving to the closed position, arced recesses 58 nest circumferentially bounding one of second pair of tang pins 28. Head member 20 is slotted interior to the pair of handles 40, accommodated by channels 60 disposed in interior edges 48 whereby head member 20 is effectively enclosed interior to the pair of handles 40 (see, e.g., FIGS. 1 and 2). Channel 60 in each interior edge 48 therefore has capacity and depth to accommodate at least one longitudinal half of head member 20.

FIG. 5 is a top elevation view of an example embodiment disposed in the closed position. Apparatus 10 is essentially the same as previously depicted in FIGS. 1 and 2 with the exception of fastener members 70 shown. In this example embodiment shown, fastener members 70 include head portion 80 and cylindrical sleeve portion 82 (not shown, but see, e.g., FIGS. 9 and 10) into which second fastener members 72 are secured via threaded portions thereof. As such, fastener members 70 and second fastener members 72 secure first ends 42 of the pair of handles 40 to tang 22 without inhibiting rotation of said first ends 42 upon and about tang 22.

FIG. 6 is a bottom diagonal elevation view of an example embodiment shown in the open position. Channel 60 is visible wherein at least half of head member 20 seats when the apparatus 10 is moved to the closed position. Magnetic portion or magnetic member 54 is visible at second end 44 of one of the pair of handles 40.

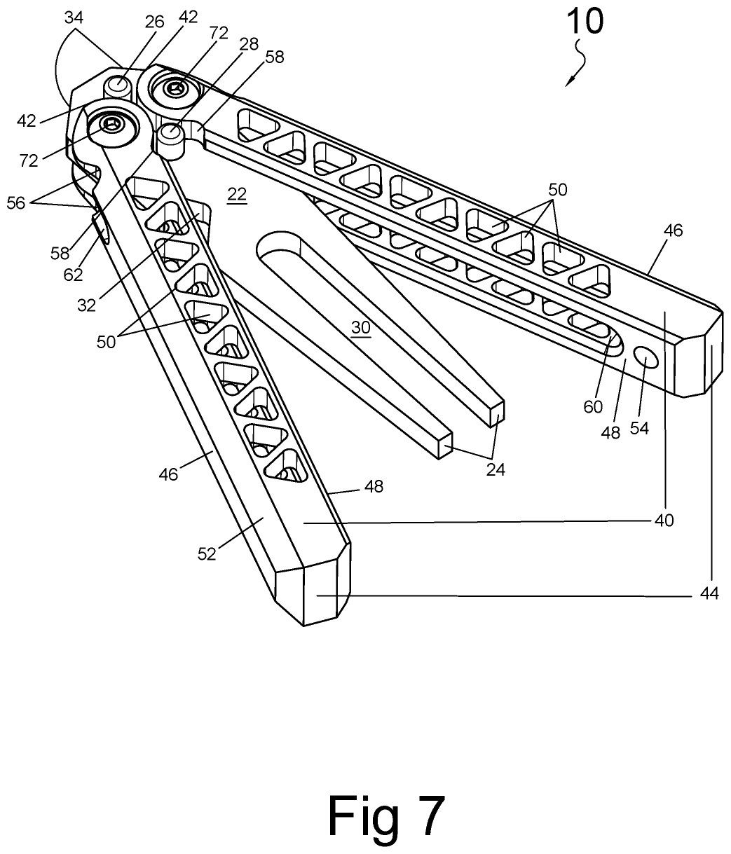

FIG. 7 is a bottom diagonal elevation view of an example embodiment shown in between the open position and the closed position. Channel 60 is visible along interior edge 48 of one of the pair of handles 40. Channel portion 62 upon exterior edge 46 of the other of pair of handles 40 is also visible, wherein tang base portion 34 seats when the apparatus 10 is moved to the open position.

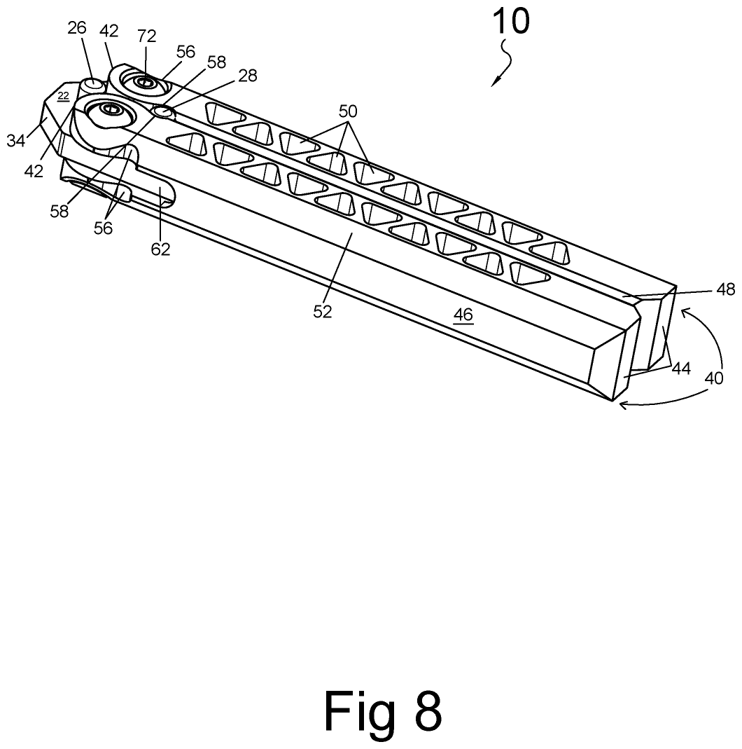

FIG. 8 is a bottom diagonal elevation view of an example embodiment in the closed position. Channel portion 62 upon exterior edge 46 is visible. Tang base portion 34 is visible. Pair of handles 40 is magnetically coupled in the closed position with interior edges 48 adjacently conjunct (see, e.g., FIGS. 6, 7, 9, and 10).

FIG. 9 is an exploded bottom elevation view of an example embodiment in the open position illustrating action of fastener members 70 coupling first ends 42 of pair of handles 40 to tang 44. In this example embodiment, fastener members 70 engage via threads with second fastener members 72 interior to cylindrical sleeve portions 82 inserted through holes 84 in first end 42 and corresponding holes in tang 22 (not shown). Second fastener members 72 engage against interior of fastener members' 70 cylindrical sleeve portion 82, thereby securing first ends 42 to tang 22 without inhibiting counter-rotation of the pair of handles 40 thereabouts. In this example embodiment, rotation is effectuated axially about cylindrical sleeve portion 82 of fastener members 70. Additional means of securing first ends 42 of the pair of handles 40 to tang 22 while enabling and/or facilitating counter-rotation thereabouts are contemplated as within scope of this disclosure, as seen in the art.

FIG. 10 is an exploded top elevation view of an example embodiment in the open position also illustrating action of fastener members 70 coupling first ends 42 of pair of handles 40 to tang 22, as previously described.

1. A counter-rotatable divot repair apparatus comprising:
a bladeless head member having:
a tang;
one pair of tine members anteriorly projected from the tang, each of said one pair of tine members adjacently disposed bordering an intermediary space that is approximately at least half as wide as the tang;
a pair of handles, each of said pair of handles having:
a first end rotatably coupled to the tang;
a second end;
an interior edge;
an exterior edge; and
a channel disposed along the interior edge, said channel disposed to a depth within the interior edge configured to accommodate at least half the head member therein;
wherein the pair of handles counter-rotate between an open position, in which the head member is exposed anteriorly projected from the first end and the exterior edge of each of the pair of handles is adjacently conjunct, and a closed position, in which the head member is enclosed within the channel of each of the pair of handles and the interior edge of each of the pair of handles is adjacently conjunct.

2. The counter-rotatable divot repair apparatus of claim 1 wherein the head member further comprises:
a first pair of tang pins disposed perpendicularly upon either side of the tang;
a second pair of tang pins disposed perpendicularly upon either side of the tang and spaced anteriorly from the first pair of tang pins more proximal the pair tine members; and
each of the pair of handles further comprises:
a curved recess disposed upon the interior and exterior edges proximal the first end;
wherein the first pair of tang pins engage into the recess cut into the interior edge of each of the pair of handles when the pair of handles is disposed in the closed, and the open, position and wherein the second pair of tang pins engage into the recess cut into the exterior edge of each of the pair of handles when the pair of handles is disposed in the open position.

3. The counter-rotatable divot repair apparatus of claim 2 wherein the head member further comprises a bottle opener section disposed edgewise upon one side of the tang.

4. The counter-rotatable divot repair apparatus of claim 2 wherein each of the pair of handles further comprises a complementary magnet disposed proximal the second end wherein each of the pair of handles is magnetically coupled when in the closed position.

5. The counter-rotatable divot repair apparatus of claim 4 wherein each of the pair of handles is also magnetically coupled when in the open position.

6. The counter-rotatable divot repair apparatus of claim 2 wherein the first end of each of the pair of handles is rotatably coupled to the tang by a fastener member inserted therethrough.

7. The counter-rotatable divot repair apparatus of claim 6 wherein each of the pair of handle members further comprises a channel portion upon the exterior edge proximal the first end, said channel portion configured to accommodate portions of the tang when the apparatus is moved to the open position.

8. The counter-rotatable divot repair apparatus of claim 7 wherein the fastener member is secured to the head member by engagement with a second fastener member insertable thereinto from an opposite side of the apparatus than the fastener member.
